(19) United States
(12) Patent Application Publication
(10) Pub. No.: US 2018/0181584 A1
(43) Pub. Date: Jun. 28, 2018

(54) METHOD AND SYSTEM FOR MAINTAINING AND SEARCHING INDEX RECORDS

(71) Applicant: NEXENTA SYSTEMS, INC., Santa Clara, CA (US)

(72) Inventor: Caitlin BESTLER, Sunnyvale, CA (US)

(73) Assignee: NEXENTA SYSTEMS, INC., Santa Clara, CA (US)

(21) Appl. No.: 15/390,124

(22) Filed: Dec. 23, 2016

(51) Int. Cl. G06F 17/30

(52) U.S. Cl. CPC G06F 17/30094; G06F 17/3012

(57) ABSTRACT

One difficult problem is that a straightforward renaming of a directory containing a very large number of subdirectories and files requires locking and then updating, in parallel, the names of vast numbers of directory records. Another problem is that renaming a directory with a very large number of subdirectories and files may cause a mass migration of the metadata for the renamed objects due to their object names being changed. The presently-disclosed solution involves at least a) introducing a “folder” object and b) extending the distributed searchable set of records in the namespace manifest with a “folder” index record. In an exemplary implementation, each instance of a folder object created is described by an instance of a folder index record that is recorded in a namespace manifest. Different embodiments of the solution may be particularly suited to different use cases.

### TECHNICAL FIELD

The present disclosure relates to distributed object storage systems that support hierarchical user directories within its namespace.

### BACKGROUND OF THE INVENTION

With the increasing amount of data is being created, there is increasing demand for data storage solutions. Storing data using a cloud storage service is a solution that is growing in popularity. A cloud storage service may be publicly-available or private to a particular enterprise or organization.

A cloud storage system may be implemented as an object storage cluster that provides “get” and “put” access to objects, where an object includes a payload of data being stored. The payload of an object may be stored in parts referred to as “chunks”. Using chunks enables the parallel transfer of the payload and allows the payload of a single large object to be spread over multiple storage servers.

An object storage cluster may be used to store files organized in a hierarchical directory structure. This may be done by encoding each file or directory as a single object. The file object may have a version manifest that points to the payload chunks that contain the content of the file. The directory object may have a version manifest that enumerates zero or more sub-directories and/or files that are encoded within the directory.

### SUMMARY

One difficult problem is that a straightforward renaming of a directory containing a very large number of subdirectories and files using flat name indexing records requires locking and then updating, in parallel, the names of vast numbers of directory records. Another problem is that renaming a directory with a very large number of subdirectories and files may cause a mass migration of the metadata for the renamed objects to different storage servers due to their object names being changed.

The presently-disclosed solution involves at least a) introducing a “folder” object and b) extending the distributed searchable set of records in the namespace manifest with a “folder” index record. In an exemplary implementation, each instance of a folder object created is described by an instance of a folder index record that is recorded in a namespace manifest. Different embodiments of the solution may be particularly suited to different use cases.

### BRIEF DESCRIPTION OF THE DRAWINGS

FIG. 1 depicts a folder object and a folder index record of a presently-disclosed solution that overcomes problems relating to a hierarchical directory structure implemented in an object storage system with distributed object metadata.

FIG. 2 depicts components of a first embodiment of the presently-disclosed solution.

FIG. 3 is a flow chart of an exemplary method that utilizes the components of FIG. 2 to rename a remapped folder to an alias folder by providing, in effect, a symbolic link between the alias folder and the remapped folder.

FIG. 4 depicts components of a second embodiment of the presently-disclosed solution.

FIG. 5 is a flow chart of an exemplary method that utilizes the components of FIG. 4 to efficiently rename an existing (old) folder.

FIG. 6 depicts components of a third embodiment of the presently-disclosed solution.

FIG. 7 is a flow chart of an exemplary method that utilizes the components of FIG. 6 to efficiently clone an existing (old) folder.

FIG. 8 is a flow chart showing steps of a variation of the method of FIG. 7.

FIG. 9 is a simplified diagram showing components of a computer apparatus that may be used to implement elements (including, for example, client computers, gateway servers and storage servers) of an object storage system.

FIG. 10 depicts an exemplary object storage system in which the presently-disclosed solutions may be implemented.

FIG. 11 depicts a distributed namespace manifest and local transaction logs for each storage server of an exemplary storage system in which the presently-disclosed solutions may be implemented.

FIG. 12A depicts an exemplary relationship between an object name received in a put operation, namespace manifest shards, and the namespace manifest.

FIG. 12B depicts an exemplary structure of one types of entry that can be stored in a namespace manifest shard.

FIG. 12C depicts an exemplary structure of another type of entry that can be stored in a namespace manifest shard.

FIG. 13 depicts a snapshot creation method.

FIG. 14 depicts the creation of a snapshot manifest at different instances in time.

FIG. 15 depicts exemplary content of a record in a snapshot manifest.

### DETAILED DESCRIPTION

Select Challenges and Problems

To meet the increasing demands to scale out storage, an object storage cluster may distribute not only payload data, but also object metadata. The metadata for an object may be distributed to different storage servers based, for example, upon the object name.

Unfortunately, as is pertinent to the present disclosure, while such distribution of the object metadata has its advantages, it also poses substantial problems to enabling the use of certain POSIX (portable operating system interface) compatible commands for a hierarchical file structure stored in the object storage cluster. Of particular interest, POSIX-compatible commands that involve renaming of a directory in a hierarchical file structure, aliasing or duplicating a large portion of the hierarchical file structure, are problematic to implement in a straightforward manner.

Hierarchical naming structures store the naming information one directory layer at a time. Hence, there is an object which translates the names directly descended from the root (typically “I”). The sub-directories of the root are encoded in different objects, which contain directory information for their sub-directories and directly included files. In such a hierarchical naming structure, renaming a directory can be simply accomplished by editing the entry referring to it in its parent directory. This single edit effectively renames the directory and all of its descendants. However, this comes at the potentially very high cost of requiring iterative resolution of the fully-qualified name.

In hierarchical naming metadata, a fully qualified name is resolved iteratively. This means that the name is parsed into a series of names that are resolved within the context established by the prior names. The first name is resolved in the context of the root directory. The second name is resolved in the context of the sub-directory pointed at within the root directory. This continues until a file, rather than a sub-directory, is resolved. For example, the fully qualified name “/A/B/C/D/E.txt” is resolved in the following steps (using “1” as the directory separator): “A/” is found within the “I” directory; “B/” is found within the “/A/” directory; “C/” is found within the “/A/B/” directory; “D/” is found within the “/A/B/C/” directory; and “E.txt” is found within the “/A/B/C/D/” directory. Editing the “C/” entry within the “/A/B/” to “CC/” directory changes the name of all files and sub-directories starting at “/A/B/C/” to “/A/B/CC/”.

Consider a straightforward renaming of a directory that logically encloses a very large number of subdirectories and files, or a straightforward duplication of such a large directory. Such an operation is problematic because it requires locking and then updating, in parallel, the names of vast numbers of directory records. This is impractical because it can slow down a large portion of the object storage cluster for a single rename or duplication operation.

Another problem occurs when the distribution of the object metadata to the storage servers depends on the object name. In such a case, renaming or duplicating a large directory causes a mass migration or mass duplication of the metadata for the renamed or duplicated objects.

Presently-Disclosed Solution

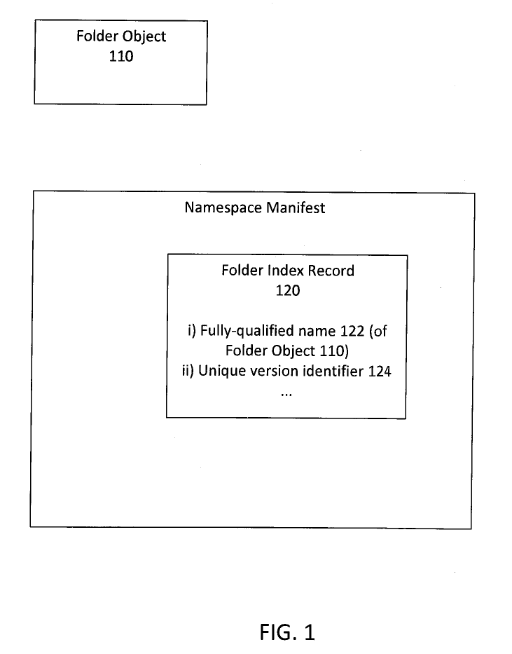

The present disclosure provides a solution to these problems. In general, as depicted in FIG. 1, the solution involves at least a) introducing a “folder” object 110 and b) extending the distributed searchable set of records in the namespace manifest with a “folder” index record 120. In an exemplary implementation, each instance of a folder object created, either explicitly using POSIX or Object APIs, or implicitly by Object APIs, is described by an instance of a folder index record that is recorded in a namespace manifest. Different embodiments of the solution are described below.

The folder object 110 represents a folder (also called a directory) that encodes metadata attributes that apply to the folder and are typically inherited by all objects that are “within” the folder object 110. Note that, unlike a folder encoding in a hierarchical naming scheme, in the present invention the folder object does not enumerate its direct descendants. Instead, the fully-qualified name and timestamp of each object version determines which folders it is logically enclosed within. More particularly, if the object version's fully-qualified name has a prefix that matches the name of a “folder” object version, and the timestamp of the creation of the object version is within the effective time range of the folder object version (i.e. after the timestamp of the folder object version and before the timestamp of a next version of the folder object), then the object version is considered to be logically enclosed by that folder object version.

As a first example, consider that the object version's name is /a/b/c/d and timestamp is t1, and the folder object version has the name /a/b/ and effective time range from t2 to t3. In this example, the object version's name has the prefix /a/b/, so the object version is logically enclosed in the folder object version if t1 is between t2 and t3.

As a second example, the object version has name /a/b/c/d and timestamp t1, and the folder object version has name /a/e/and effective time range from t4 to t5. In this case, because the object version's name does not have the prefix /a/e/, the object version is not logically enclosed in the folder object version (no matter the timestamps).

Creating an Alias Folder

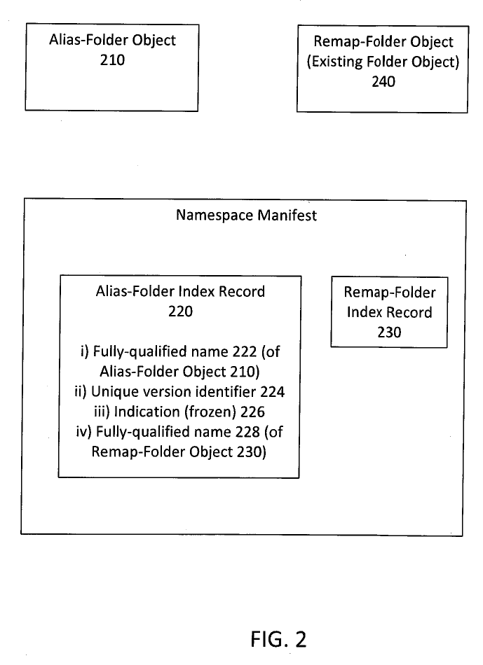

A first embodiment of the solution effectively implements a POSIX command to create an additional folder name to access all files within a remapped folder via an alias folder. This is accomplished by creating, in effect, an alias folder that is symbolically linked to a remapped folder. As depicted in FIG. 2, this embodiment a) introduces an “alias-folder” object 210 and b) extends the distributed searchable set of records in the namespace with an “alias-folder” index record 220. Object instances (i.e. object versions) that have a name prefix matching the remapped folder object's name, and which have a timestamp that falls within the effective time range of the alias folder object version, are logically considered to also be enclosed by the alias folder.

The alias-folder index record 220 specifies i) the fully-qualified name 222 of the alias-folder object, ii) a unique version identifier 224 which includes a creation timestamp, iii) an indication 226 that the content of the alias folder object is frozen (i.e. files, subfolders, and other objects within the alias folder cannot be created, removed, or otherwise edited), and iv) the fully-qualified name 228 of the remapped folder object (and optional filter).

Furthermore, the alias-folder index record 220 indicates that, from the time of the creation of this record until a time of creation of a later version of this record, all names that would resolve with (i.e. has a prefix that matches) the name of the alias folder are to be searched with revised names. In other words, during that time frame, each search for an object version having a name with a prefix matching the name of the alias folder would be performed with a revised name having a prefix that was changed to match the name of the remapped folder. For example, consider the case where the remapped folder name is /a/b, the alias folder name is /e/b, and the name searched is /e/b/c/d (with prefix matching the alias folder name). In this case, during the effective time of the alias-folder object version, the search would be performed with the revised name of /a/b/c/d, instead of /e/b/c/d.

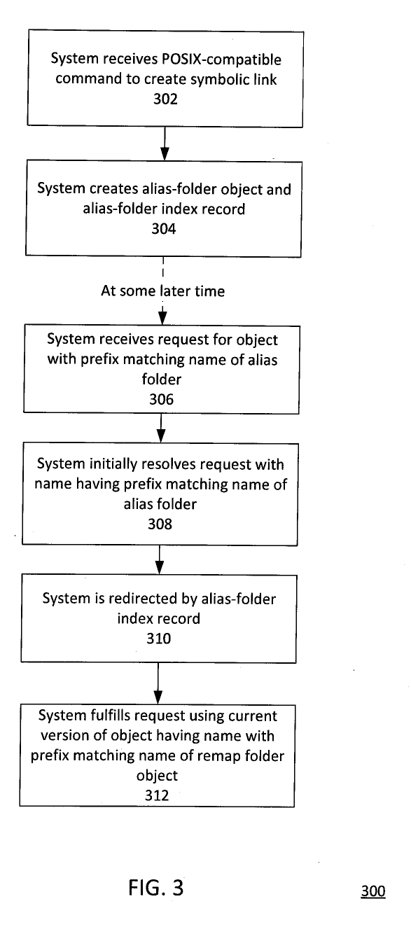

FIG. 3 is a flow chart of an exemplary method 300 of performing a POSIX-compatible command to create a symbolic link from an alias folder to a remap folder in an object storage system with distributed object metadata in accordance with an embodiment of the invention. A POSIX-compatible command to create the symbolic link may be received 302 from a user of the object storage system. In response, the object storage system may create 304 the alias folder object 210 and the alias-folder index record 220, as they are described above in relation to FIG. 2.

Thereafter, but before a time of creation of a later version of the alias-folder index record 220, a user request may be received 306 by the system for a folder, file or other object that has an object name that initially resolves 308 with (i.e. has a prefix that matches) the name of the alias folder. However, the system is, in effect, redirected 310 by the alias-folder index record 220 to search for an object with a revised name that has the name of the remapped folder substituted for the name of the alias folder. The request is thus fulfilled 312 using an object instance having a name with a prefix that matches the name of the remapped folder object 240.

Renaming a Folder

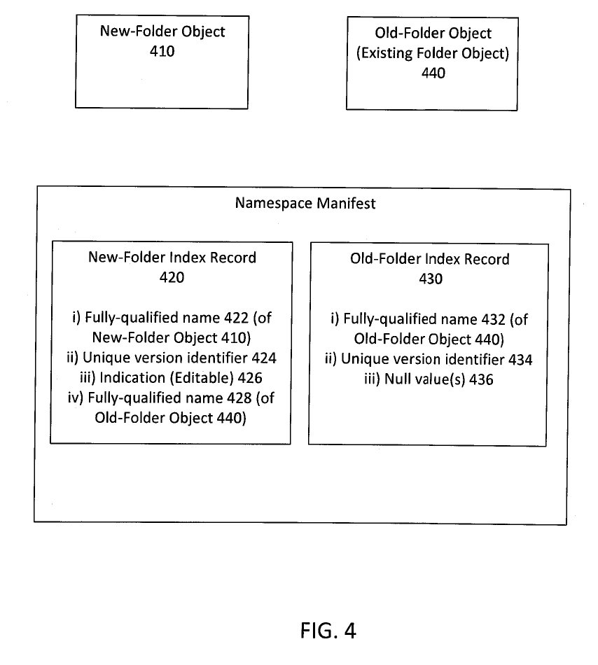

A second embodiment of the solution effectively renames an old (existing) folder from an old folder name to a new folder name. As depicted in FIG. 4, this embodiment a) introduces a “new-folder” object 410, b) creates a “new-folder” index record 420, and c) modifies an “old-folder” index record 430 that refers to the old-folder (existing) object 440.

The new-folder index record 420 specifies i) the fully-qualified name 422 of the alias-folder object, ii) a unique version identifier 424 which includes a creation timestamp, iii) an indication 426 that the content of the new-folder object 410 is editable (i.e. files, subfolders, and other objects within the new folder may be created, removed, or edited), and iv) the fully-qualified name 428 of the old-folder object 440 that is being renamed.

The old-folder index record 430, as modified, specifies i) the fully-qualified name 432 of the old folder object, ii) a unique version identifier 434 which includes a transaction timestamp of this rename transaction, and iii) null value(s) 436 to return for entries with the old folder name as the prefix name when the search is created after the timestamp of the rename transaction. In other words, the old folder name is voided as of the time of the rename transaction.

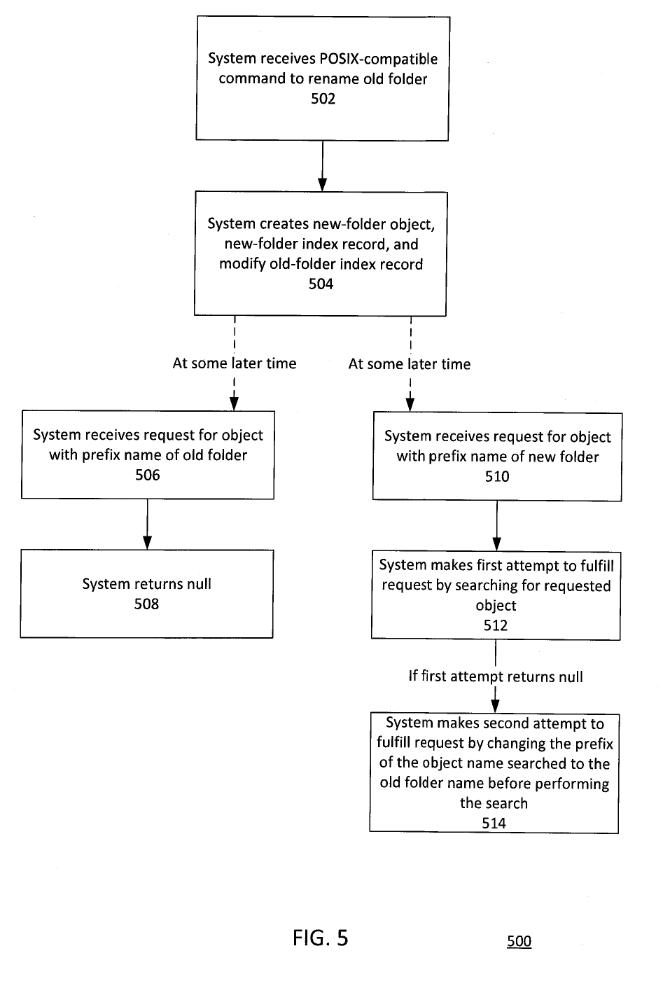

FIG. 5 is a flow chart of a first exemplary method 500 of performing a POSIX-compatible command to rename an old (i.e. existing) folder from an old folder name to a new folder name in an object storage system with distributed object metadata in accordance with an embodiment of the invention. A POSIX-compatible command to rename the old folder may be received 502 from a user of the object storage system. In response, the object storage system may create 504 the new-folder object 410 and the new-folder index record 420, and modify the old-folder index record 430, as they are described above in relation to FIG. 4.

Thereafter, a user request may be received 506 by the system for a folder, file or other object with the old folder name as the prefix name. Due to the voiding of the old folder name, a null is returned 508 by the system. On the other hand, a user request may be received 510 by the system for an object (folder, file or other object) with the new folder name as the prefix of the object name. Due to the renaming transaction, the system makes a first attempt 512 to fulfill the request by searching for a current version of the requested object (with the new folder name as the prefix of the object name searched), and if that attempt returns a null, then makes a second attempt 514 to fulfill the request by changing the prefix of the object name searched to the old folder name before performing the search.

Cloning a Folder

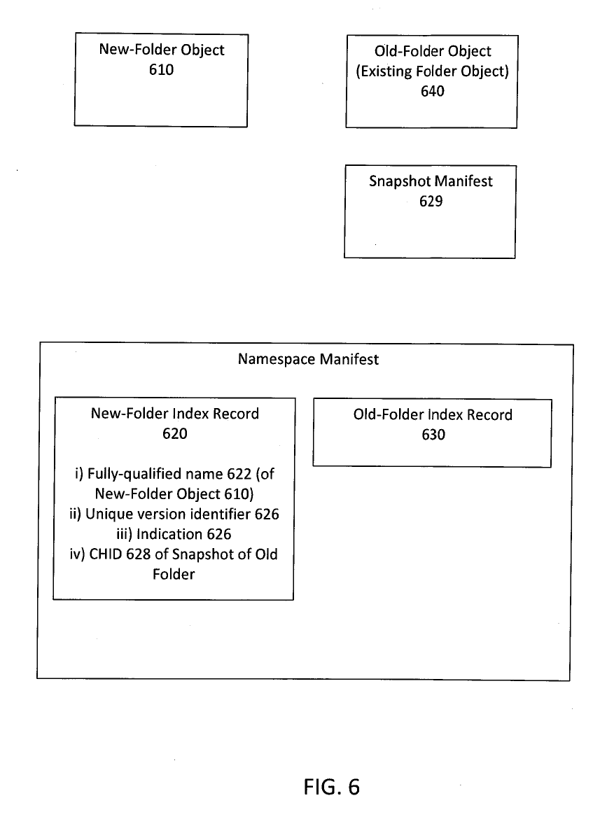

The third embodiment of the solution creates a new namespace which also references all of the object versions which were part of a prior namespace when a specific snapshot was taken. As depicted in FIG. 6, this embodiment a) introduces a “new-folder” object 610, b) creates a “new-folder” index record 620, and c) references a snapshot of the portion of the name manifest relating to the old folder to make a snapshot manifest 629. The same command may optionally create a snapshot of an old-folder rather than relying on an existing snapshot. The old-folder index record 630 and the old-folder object 640 may remain unmodified by this transaction.

The new-folder index record 620 specifies i) the fully-qualified name 622 of the new folder object 610, ii) a unique version identifier 624 which includes a transaction timestamp of this rename transaction, iii) an indication 626 that the content of the new folder object is changeable (i.e. files, subfolders, and other objects within the new folder may be created, removed or edited), and iv) a content hash identifier (CHID) 628 of a snapshot manifest 629 of the portion of the namespace manifest relating to the old folder at the time of this rename transaction. The snapshot manifest 629 effectively captures the contents of the old folder at that point in time. In addition, a source prefix name and pattern may be included, but these are only used until the snapshot CHID 628 is available.

Note that the snapshot of the contents of the old folder and the editable new folder together create, if effect, an editable “clone” of the old folder. This editable clone does not interfere with the “original” old folder. From the time of cloning onwards, the contents of the original and the clone may diverge.

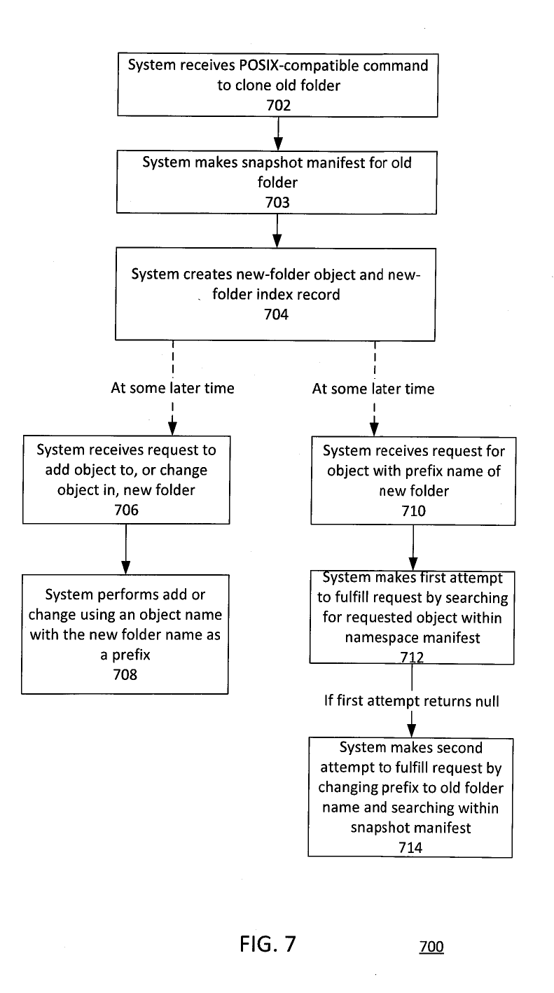

FIG. 7 is a flow chart of an exemplary method 700 of performing a POSIX-compatible command to clone an existing folder from an old folder name to a new folder name in an object storage system with distributed object metadata in accordance with an embodiment of the invention. A POSIX-compatible command to clone the old (existing) folder may be received 702 from a user of the object storage system. In response, the object storage system makes 703 a snapshot manifest for the old folder and creates 704 the new-folder object 610 and the new-folder index record 620, as they are described above in relation to FIG. 6.

Thereafter, a user request may be received 706 by the system to add object to, or change object in, the new folder. Since the new-folder object is editable, the add or change may be performed using an object name reflecting the new-folder name (i.e. using an object name with the new folder name as a prefix).

On the other hand, a user request may be received 710 by the system for a folder, file or other object with the new folder name as a prefix in the object name. Due to the renaming transaction, the system makes a first attempt 712 to fulfill the request by searching for a current version of the requested object (with the specified object name having the new folder name as a prefix) in the namespace manifest, and if that attempt returns a null, then makes a second attempt 714 to fulfill the request by searching in the snapshot manifest 629 for a most-recent version of an object having a revised object name, where the revised object name is formed by substituting the old folder name for the new folder name in the prefix. Serializing the steps of the search as described is optional. The second “step” may partially or fully overlap the “first” search so long as results from the “second” search do not take precedence over results from the “first’ search.

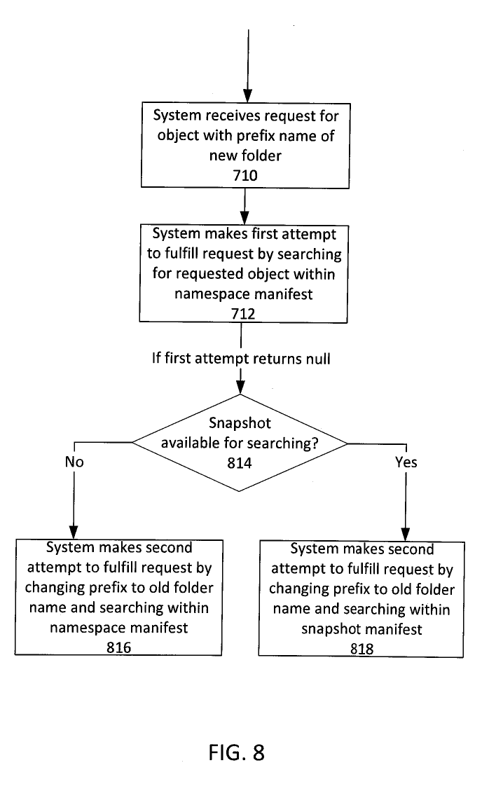

FIG. 8 is a flow chart depicting a variation 800 of the exemplary method 700 of FIG. 7. In this variation, after the system makes the first attempt 712 to fulfill the request by searching for the current version of the requested object (which has an object name with the new folder name as a prefix), a determination 814 is made as to whether the snapshot of the old folder is available for searching. If the snapshot is not ready for searching, then the system makes a second attempt 816 to fulfill the request by searching the namespace manifest for a most recent version of the requested object under the revised object name (where the revised object name is formed by substituting the old folder name for the new folder name in the prefix). If the snapshot is ready for searching, then the system makes a second attempt 818 to fulfill the request by searching for the revised object name within the snapshot manifest.

Simplified Illustration of a Computer Apparatus

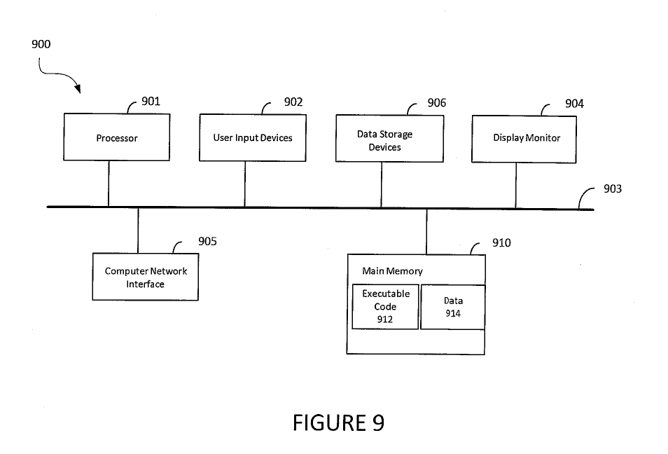

FIG. 9 is a simplified illustration of a computer apparatus that may be utilized as a client or a server of the storage system in accordance with an embodiment of the invention. This figure shows just one simplified example of such a computer. Many other types of computers may also be employed, such as multi-processor computers, for example.

As shown, the computer apparatus 900 may include a microprocessor (processor) 901. The computer apparatus 900 may have one or more buses 903 communicatively interconnecting its various components. The computer apparatus 900 may include one or more user input devices 902 (e.g., keyboard, mouse, etc.), a display monitor 904 (e.g., liquid crystal display, flat panel monitor, etc.), a computer network interface 905 (e.g., network adapter, modem), and a data storage system that may include one or more data storage devices 906 which may store data on a hard drive, semiconductor-based memory, optical disk, or other tangible non-transitory computer-readable storage media 907, and a main memory 910 which may be implemented using random access memory, for example.

In the example shown in this figure, the main memory 910 includes instruction code 912 and data 914. The instruction code 912 may comprise computer-readable program code (i.e., software) components which may be loaded from the tangible non-transitory computer-readable medium 907 of the data storage device 906 to the main memory 910 for execution by the processor 901. In particular, the instruction code 912 may be programmed to cause the computer apparatus 900 to perform the methods described herein.

Exemplary Object Storage System

The present disclosure relates to distributed object storage systems that support naming metadata as though they were organized as hierarchical directory structures (i.e. hierarchical user directories) within its namespace. The namespace itself is stored as a distributed object. When a new object is added or updated as a result of a put transaction, metadata relating to the object's name eventually is stored in a namespace manifest shard based on the key derived from the full name of the object.

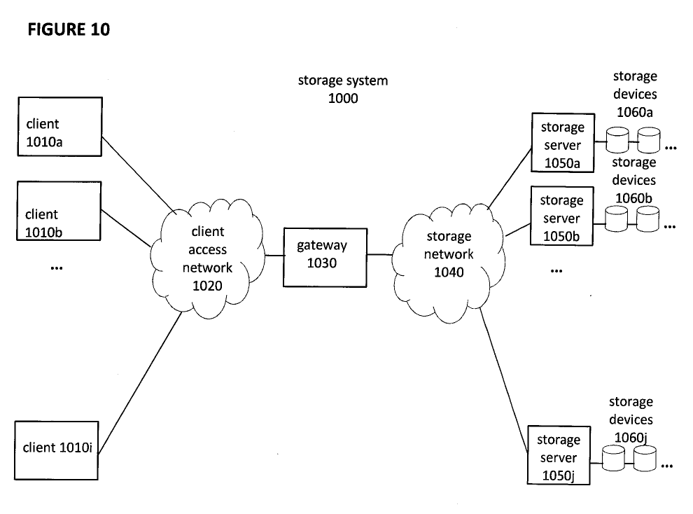

FIG. 10 depicts an exemplary object storage system 1000 in which the presently-disclosed solutions may be implemented. The storage system 1000 comprises clients 1010a, 1010b, . . . 1010i (where i is any integer value), which access gateway 1030 over client access network 1020. There can be multiple gateways and client access networks, and that gateway 1030 and client access network 1020 are merely exemplary. Gateway 1030 in turn accesses Storage Network 1040, which in turn accesses storage servers 1050a, 1050b, . . . 1050j (where j is any integer value). Each of the storage servers 1050a, 1050b, . . . , 1050j is coupled to a plurality of storage devices 1060a, 1060b, . . . 1060j, respectively.

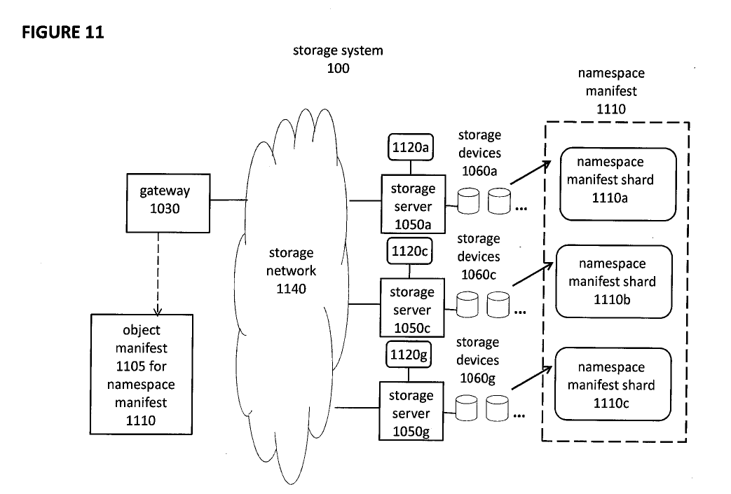

FIG. 11 depicts certain further aspects of the storage system 1000 in which the presently-disclosed solutions may be implemented. As depicted, gateway 1030 can access object manifest 1105 for the namespace manifest 1111. Object manifest 1105 for namespace manifest 1111 contains information for locating namespace manifest 1111, which itself is an object stored in storage system 1000. In this example, namespace manifest 1111 is stored as an object comprising three shards, namespace manifest shards 1111a, 1111b, and 1111c. This is representative only, and namespace manifest 1111 can be stored as one or more shards. In this example, the object has been divided into three shards and have been assigned to storage servers 1050a, 1050c, and 1050g. Typically each shard is replicated to multiple servers as described for generic objects in the Incorporated References. These extra replicas have been omitted to simplify the diagram.

The role of the object manifest is to identify the shards of the namespace manifest. An implementation may do this either as an explicit manifest which enumerates the shards, or as a management plane configuration rule which describes the set of shards that are to exist for each managed namespace. An example of a management plane rule would dictate that the TenantX namespace was to spread evenly over 20 shards anchored on the name hash of “TenantX”.

In addition, each storage server maintains a local transaction log. For example, storage server 1050a stores transaction log 1120a, storage server 1050c stores transaction log 1120c, and storage serve 1050g stores transaction log 1120g.

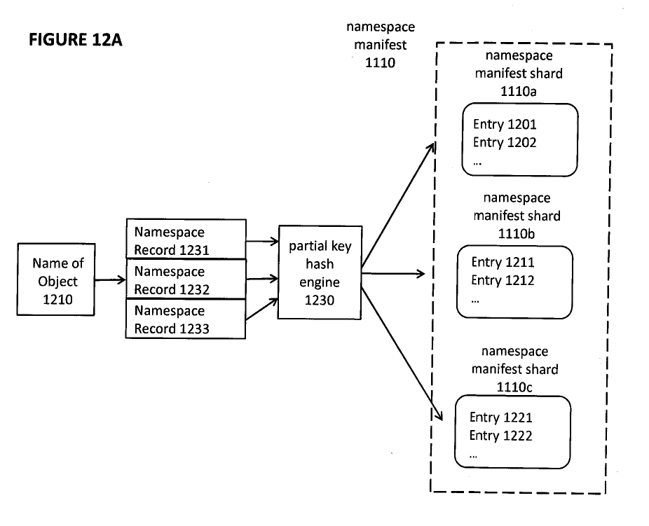

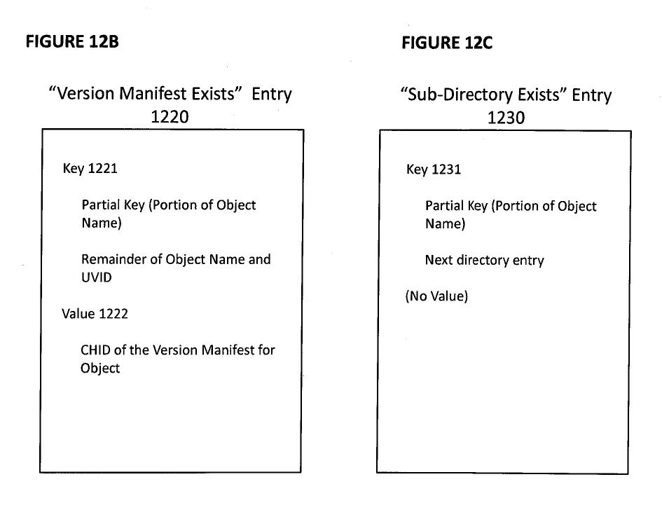

With reference to FIG. 12A, the relationship between object names and namespace manifest 1110 is depicted. Exemplary name of object 1210 is received, for example, as part of a put transaction. Multiple records (here shown as namespace records 1231, 1232, and 1233) that are to be merged with namespace manifest 1110 are generated using the iterative or inclusive technique previously described. The partial key has engine 1230 runs a hash on a partial key (discussed below) against each of these exemplary namespace records 1231, 1232, and 1233 and assigns each record to a namespace manifest shard, here shown as exemplary namespace manifest shards 1110a, 1110b, and 1110c.

Each namespace manifest shard 1110a, 1110b, and 1110c can comprise one or more entries, here shown as exemplary entries 1201, 1202, 1211, 1212, 1221, and 1222.

The use of multiple namespace manifest shards has numerous benefits. For example, if the system instead stored the entire contents of the namespace manifest on a single storage server, the resulting system would incur a major non-scalable performance bottleneck whenever numerous updates need to be made to the namespace manifest.

With reference now to FIGS. 12B and 12C, the structure of two possible entries in a namespace manifest shard are depicted. These entries can be used, for example, as entries 1201, 1202, 1211, 1212, 1221, and 1222 in FIG. 12A.

FIG. 12B depicts a “Version Manifest Exists” entry 1220, which is used to store an object name (as opposed to a directory that in turn contains the object name). Object name entry 1220 comprises key 1221, which comprises the partial key and the remainder of the object name and the UVID. In the preferred embodiment, the partial key is demarcated from the remainder of the object name and the UVID using a separator such as “i” and “\” rather than “I” (which is used to indicate a change in directory level). The value 1222 associated with key 1221 is the CHID of the version manifest for the object 1210, which is used to store or retrieve the underlying data for object 1210.

FIG. 12C depicts “Sub-Directory Exists” entry 1230. Sub-directory entry 1230 comprises key 1231, which comprises the partial key and the next directory entry.

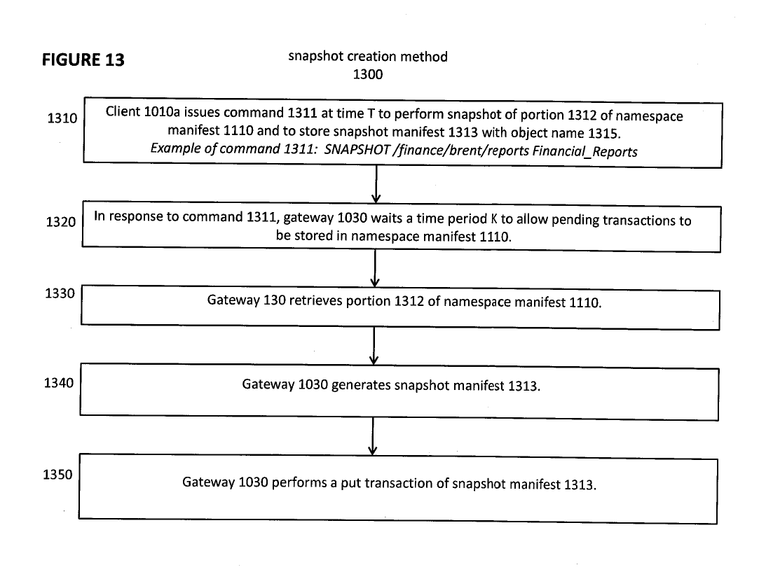

For example, if object 1210 is named “/Tenant/A/B/C/d.docx,” the partial key could be “/Tenant/A/”, and the next directory entry would be “B/”. No value is stored for key 1231. With reference to FIG. 13, snapshot creation method 1300 is depicted. Creation of a snapshot, or a new version of a snapshot, is typically initiated via a client 1010a, 1010b, . . . 1010i by an administrator or by an automated management system that uses the corresponding client interface. For shortness sake, snapshot initiator denotes henceforth any client of the storage system that initiates snapshot creation.

First, exemplary a snapshot initiator (shown as client 110a) issues command 1311 at time T to perform a snapshot of portion 1312 of namespace manifest 1110 and to store snapshot object 1313 with object name 1315. Portion 1312 can comprise the entire namespace manifest 1110, or portion 1312 can be a sub-set of namespace manifest 1110. For example, portion 1312 can be expressed as one or more directory entries or as a specific enumeration of one or more objects. An example of command 1311 would be: SNAPSHOT/finance/brent/reports Financial_Reports. In this example, “SNAPSHOT” is command 1311, “/finance/brent/reports” is the identification of portion 1312, and “Financial_Reports” is object name 1315. The command may be implemented in one of many different formats, including binary, textual, command line, or HTTP/REST. (Step 1310).

Second, in response to command 1311, gateway 1030 waits a time period K to allow pending transactions to be stored in namespace manifest 1110. (Step 1320). Third, gateway 1030 retrieves portion 1312 of namespace manifest 1110. This step involves retrieving the namespace manifest shards that correspond to portion 1312. (Step 1330).

Fourth, in response to command 1311, gateway 1030 retrieves all transaction logs 1120 and identifies all pending transactions 1331 at time T. (Step 1330). These records cannot be used for the snapshot until all transactions that were initiated at or before Time T are represented in one or more Namespace Manifest shards. Thus, a snapshot at Time T cannot be created until time T+K, where K represents an implementation-dependent maximum propagation delay. The delay of time K allows all transactions that are pending in transaction logs (such as transaction logs 1120a . . . 1120g) to be stored in the appropriate namespace shards. While the records for the snapshot cannot be collected before this minimal delay, they will still represent a snapshot at time T. It should be understood that allowing for a maximum delay requires allowing for congested networks and busy servers, which may compromise prompt availability of snapshots. An alternative implementation could use a multicast synchronization, such as found in the MPI standards, to confirm that all transactions as of time T have been merged into the namespace manifest.

Fifth, gateway 1030 generates snapshot object 1313. This step involves parsing the entries of each namespace manifest shard to identify the entries that relate to portion 1312 (which will be necessary if portion 1312 does not align completely with the contents of a namespace manifest shard), storing the namespace manifest shards or entries in memory, storing all pending transactions 1331 pending at time T from all transaction logs 1120, and creating snapshot object 1313 with object name 1315 (Step 1340).

Finally, gateway 1030 performs a put transaction of snapshot object 1313 to store it. This step uses the same procedure described previously as to the storage of an object. (Step 1350).

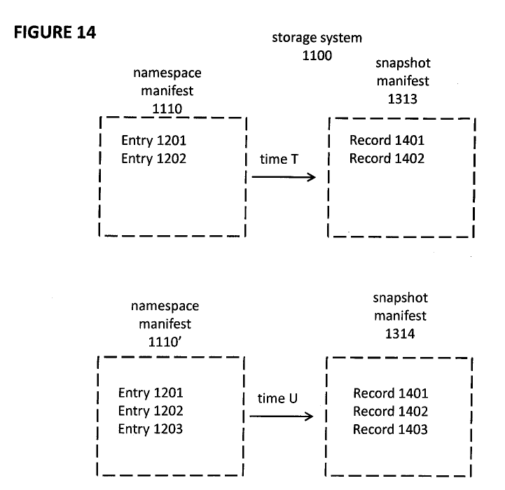

With reference to FIG. 14, two snapshots within storage system 1000 are depicted for the simplified scenario where no transactions are pending in transaction logs 1120 at the time of the snapshot. At time T, snapshot manifest 1313 is created from namespace manifest 1110 or a portion thereof. At time U, snapshot manifest 1314 is created from namespace manifest 1110′ or a portion thereof. Notably, at time U, the state of storage system 100 is different than it was at time T. In this example, namespace manifest 1110′ contains entry 1203 that was not present in namespace manifest 1110.

As can be seen in FIG. 14, each record in the namespace manifest or a portion thereof results in the creation of a record in the snapshot manifest. Thus, record 1401 corresponds to entry 1201, record 1402 corresponds to entry 1202, and record 1403 corresponds to entry 1203. A snapshot manifest (such as snapshot manifest 1313 or 1314) is a sharded object that is created by a MapReduce job which selects a subset of records from a namespace manifest (such as namespace manifest 1110) or a portion thereof, or another version of a snapshot manifest. The MapReduce job which creates a version of a snapshot manifest is not required to execute instantaneously, but the extract created will represent a snapshot of a subset of a namespace

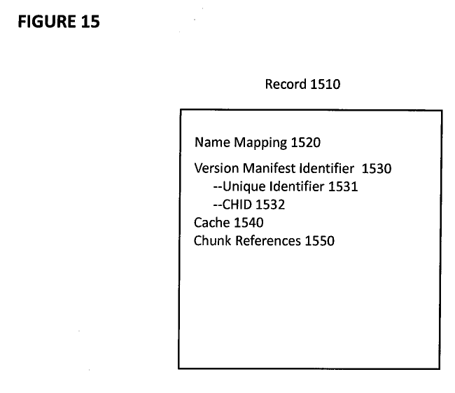

FIG. 15 depicts exemplary content of a record 1510 in a snapshot manifest. As shown, the record 1510 includes: name mapping data 1520; a version manifest identifier 1530 that includes a unique identifier 1531 and a content hash identifier 1532; cache 1540; and chunk references 1550 for the object.

The name mapping data 1520 encodes information for any name that corresponds to a conventional hierarchical directory found in the subject of the snapshot, such as namespace manifest 1110 or a portion thereof. Name mapping 1520 specifies the mapping of a relative name to a fully qualified name. This may merely document the existence of a sub-directory, or may be used to link to another name, effectively creating a symbolic link in the distributed object cluster namespace.

Version manifest identifier 1530 identifies the existence of a specific version manifest by specifying at least the following information: (1) Unique identifier 1531 for the record, unique identifier 1531 comprising the fully qualified name of the enclosing directory, the relative name of the object, and a unique identifier of the version of the object. In the preferred embodiment, unique identifier 1531 comprises a transactional timestamp concatenated with a unique identifier of the source of the transaction. (2) Content hash-identifier (CHID) 1532 of the version manifest. (3) A cache 1540 of records from the version manifest to optimize their retrieval. These records have a value cached from the version manifest and the key for that record, which identifies the version manifest and the key value within the version manifest.

What is claimed is:

1. A method of making changes to a distributed naming index for a distributed storage cluster which is organized as flat entries with transactions that are optimized for a hierarchical name index with a number of edits required that does not increase with the number of objects impacted by the edit, the method comprising:
receiving a request to perform a POSIX-compatible command that makes a change to the distributed name index as though it were a hierarchical name index;
creating a folder object that is stored in the distributed object storage system;
creating a folder index record in a namespace manifest that is stored in the distributed object storage system; and
on subsequent reads, returning results that are consistent with results that would have been returned had the transaction been performed on the hierarchical name index.

2. The method of claim 1, wherein the POSIX-compatible command requests mapping all names starting with the name of an alias folder to that of a remapped folder.

3. The method of claim 2, wherein the folder object is an alias-folder object, and the folder index record is an alias-folder index record.

4. The method of claim 3, wherein the alias-folder index record includes a name of the alias-folder object, a unique version identifier of the alias-folder object, an indication that content of the alias-folder object is non-editable, and a name of the remapped folder object.

5. The method of claim 4, further comprising:
receiving a request to access a file object with a name that has a prefix matching the name of the alias-folder object; and
accessing the alias-folder index record and being redirected to search for a file object with a revised name, wherein the revised name has a prefix matching the name of the remapped folder object.

6. The method of claim 1, wherein the POSIX-compatible command requests renaming of an old folder stored as an object in the distributed object storage system from an old folder name to a new folder name.

7. The method of claim 6, wherein the folder object is a new-folder object, and the folder index record is a new-folder index record, and wherein the new-folder index record includes the new folder name, a unique version identifier of the new-folder object, an indication that content of the new-folder object is editable, and the old folder name.

8. The method of claim 7, further comprising:
creating a new version an old-folder index record to indicate that content of the old-folder object is non-editable and non-accessible as of the effective time for this version of the old-folder.

9. The method of claim 8, further comprising:
receiving a request to obtain an object having an object name with a prefix that is the new folder name;
making a first attempt to obtain the object by searching the namespace manifest for the object name; and
making a second attempt to obtain the object by searching the namespace manifest for a revised object name when the first attempt returns a null result, where the revised object name has the old folder name substituted for the new folder name in the prefix of the object name.

10. The method of claim 1, wherein the POSIX-compatible command requests cloning of an old folder stored as an object in the distributed object storage system, and wherein the folder object is a new-folder object, and the folder index record is a new-folder index record.

11. The method of claim 10, further comprising:
determining a subset of the namespace manifest that is relevant to the old folder;
creating a snapshot of the subset of the namespace manifest.

12. The method of claim 11, wherein the new-folder index record includes a name of the new folder, a unique version identifier of the new-folder object, an indication that content of the new-folder object is editable, and content hash identifier of the snapshot.

13. The method of claim 12, further comprising:
receiving a request to obtain an object having an object name with a prefix that is the new folder name;
making a first attempt to obtain the object by searching the namespace manifest for the object name; and
making a second attempt to obtain the object by searching the snapshot manifest for a revised object name when the first attempt returns a null result, where the revised object name has the old folder name substituted for the new folder name in the prefix of the object name.

14. A distributed object storage system that supports creating a symbolic link to a remap folder, the system comprising:
a storage network;
a plurality of storage servers accessed by a storage network;
a plurality of clients;
a gateway server that is used by a plurality of clients to access the distributed data storage system; and
a namespace manifest that is stored in a distributed manner in the distributed data storage system,
wherein the system receives a request to perform a POSIX-compatible command that makes a change to the hierarchical file structure, and
wherein the system creates a folder object that is stored in the distributed object storage system, creates a folder index record in the namespace, and uses the folder object and the folder index record to perform the POSIX-compatible command.

15. The system of claim 14, wherein the POSIX-compatible command requests mapping all names starting with the name of an alias folder to that of a remapped folder.

16. The system of claim 15, wherein the folder object is an alias-folder object, and the folder index record is an alias-folder index record, and wherein the alias-folder index record includes a name of the alias-folder object, a unique version identifier of the alias-folder object, an indication that content of the alias-folder object is non-editable, and a name of the remapped folder object.

17. The system of claim 14, wherein the POSIX-compatible command requests renaming of an old folder stored as an object in the distributed object storage system from an old folder name to a new folder name.

18. The system of claim 17, wherein the folder object is a new-folder object, and the folder index record is a new-folder index record, and wherein the new-folder index record includes the new folder name, a unique version identifier of the new-folder object, an indication that content of the new-folder object is editable, and the old folder name.

19. The system of claim 14, wherein the POSIX-compatible command requests cloning of an old folder stored as an object in the distributed object storage system, and wherein the folder object is a new-folder object, and the folder index record is a new-folder index record.

20. The system of claim 19,
wherein the system determines a subset of the namespace manifest that is relevant to the old folder, and
wherein the system creates a snapshot of the subset of the namespace manifest.

21. The system of claim 20, wherein the new-folder index record includes a name of the new folder, a unique version identifier of the new-folder object, an indication that content of the new-folder object is editable, and content hash identifier of the snapshot.
